(19) United States
(12) Patent Application Publication
(10) Pub. No.: US 2026/0319793 A1
(43) Pub. Date: Oct. 15, 2026

(54) PROCESSOR AND COMPUTATION METHOD THEREOF

(71) Applicant: Shanghai Zhaoxin Semiconductor Co., Ltd., Shanghai (CN)

(72) Inventors: Weilin WANG, Beijing (CN); Yingbing GUAN, Shanghai (CN); Yun LI, Xi'an City (CN)

(21) Appl. No.: 19/318,619

(22) Filed: Sep. 4, 2025

(30) Foreign Application Priority Data
Apr. 15, 2025 (CN) 202510465037.X

(51) Int. Cl. G06F 9/30

(52) U.S. Cl. CPC G06F 9/30021; G06F 9/3001

(57) ABSTRACT

A processor is provided. The processor includes a first register, a decoder, and an execution unit. The first register is configured to store a first approximation-number evaluation threshold. The decoder is configured to decode an approximation-number instruction to obtain an operator, a first operand, and a second operand. The execution unit is configured to compare the first operand with the first approximation-number evaluation threshold to obtain a first comparison result. The execution unit is configured to compare the second operand with the first approximation-number evaluation threshold to obtain a second comparison result. Based on the first comparison result and the second comparison result, the execution unit is configured to selectively output the first operand, the second operand, or a computation result. The computation result is obtained by the execution unit performing an operation that corresponds to the operator on the first operand and the second operand.

### CROSS REFERENCE TO RELATED APPLICATIONS

This application claims priority of China Patent Application No. 202510465037.X, filed on Apr. 15, 2025, the entirety of which is incorporated by reference herein.

### BACKGROUND OF THE INVENTION

### Field of the Invention

The present invention relates to computer architecture, and, in particular, it relates to a processor and the computation thereof.

### Description of the Related Art

Artificial Intelligence (AI) computation involves a large number of matrix operations, especially in neural networks (NNs). In NN, the calculations between weights, biases, and input data rely on a large number of matrix multiplications and additions. Generally, AI computation will significantly increase in time and space complexity as the amount and dimensions of data increase. Therefore, how to optimize the efficiency of these computations is crucial for improving the performance of AI systems. Currently, dedicated hardware such as graphics processing units (GPUs), neural-network processing units (NPUs), and tensor processing units (TPUs) are commonly used to accelerate AI computing. However, they are expensive to produce and use. Moreover, none of them are acceleration methods that are aimed at reducing the amount of computation.

In essence, AI computation involves a large amount of matrix multiplication and addition. Multiplication and addition are types of arithmetic operations. In addition to multiplication and addition, arithmetic operations also include subtraction and division. In addition to arithmetic operations, other common operations include logical operations. Logical operations includes AND, OR, and NOT operations. Generally, arithmetic operations involve carry operations and require more complex computational logic (e.g., multiplication and division). Therefore, arithmetic operations are more time-consuming than logical operations.

Therefore, a processor and computation method that can reduce the number of arithmetic operations to accelerate AI computation are needed.

### BRIEF SUMMARY OF THE INVENTION

An embodiment of the present invention provides a processor. The processor includes a first register, a decoder, and an execution unit. The first register is configured to store a first approximation-number evaluation threshold. The decoder is configured to decode an approximation-number instruction to obtain an operator, a first operand, and a second operand. The execution unit is configured to compare the first operand with the first approximation-number evaluation threshold to obtain a first comparison result. The execution unit is configured to compare the second operand with the first approximation-number evaluation threshold to obtain a second comparison result. The execution unit is configured to selectively output, based on the first comparison result and the second comparison result, the first operand, the second operand, or a computation result. The computation result is obtained by the execution unit performing an operation corresponding to the operator on the first operand and the second operand.

In one embodiment, the execution unit includes a first comparator, a second comparator, an arithmetic logic unit, and a multiplexer. The first comparator is configured to compare the first operand with the first approximation-number evaluation threshold to obtain the first comparison result. The second comparator is configured to compare the second operand with the first approximation-number evaluation threshold to obtain the second comparison result. The arithmetic logic unit is configured to selectively perform, based on the first comparison result and the second comparison result, the operation corresponding to the operator on the first operand and the second operand. The multiplexer is configured to selectively output, based on the first comparison result and the second comparison result, the first operand, the second operand, or the computation result.

In one embodiment, in response to the operator corresponding to an addition operation and the first comparison result indicating that the first operand is not greater than the first approximation-number evaluation threshold and the second comparison result indicating that the second operand is greater than the first approximation-number evaluation threshold, the multiplexer outputs the second operand. In response to the operator corresponding to the addition operation and the first comparison result indicating that the first operand is greater than the first approximation-number evaluation threshold and the second comparison result indicating that the second operand is not greater than the first approximation-number evaluation threshold, the multiplexer outputs the first operand. In response to the operator corresponding to the addition operation and the first comparison result indicating that the first operand is not greater than the first approximation-number evaluation threshold and the second comparison result indicating that the second operand is not greater than the first approximation-number evaluation threshold, the multiplexer outputs the second operand. In response to the operator corresponding to the addition operation and the first comparison result indicating that the first operand is greater than the first approximation-number evaluation threshold and the second comparison result indicating that the second operand is greater than the first approximation-number evaluation threshold, the arithmetic logic unit performs the addition operation on the first operand and the second operand, and the multiplexer outputs the computation result.

In one embodiment, in response to the operator corresponding to a subtraction operation and the first comparison result indicating that the first operand is not greater than the first approximation-number evaluation threshold and the second comparison result indicating that the second operand is greater than the first approximation-number evaluation threshold, the arithmetic logic unit performs the subtraction operation on the first operand and the second operand, and the multiplexer outputs the computation result. In response to the operator corresponding to the subtraction operation and the first comparison result indicating that the first operand is greater than the first approximation-number evaluation threshold and the second comparison result indicating that the second operand is not greater than the first approximation-number evaluation threshold, the multiplexer outputs the first operand. In response to the operator corresponding to the subtraction operation and the first comparison result indicating that the first operand is not greater than the first approximation-number evaluation threshold and the second comparison result indicating that the second operand is not greater than the first approximation-number evaluation threshold, the multiplexer outputs the first operand. In response to the operator corresponding to the subtraction operation and the first comparison result indicating that the first operand is greater than the first approximation-number evaluation threshold and the second comparison result indicating that the second operand is greater than the first approximation-number evaluation threshold, the arithmetic logic unit performs the subtraction operation on the first operand and the second operand, and the multiplexer outputs the computation result.

In one embodiment, in response to the operator corresponding to a multiplication operation and the first comparison result indicating that the first operand is not greater than the first approximation-number evaluation threshold and the second comparison result indicating that the second operand is greater than the first approximation-number evaluation threshold, the multiplexer outputs the second operand. In response to the operator corresponding to the multiplication operation and the first comparison result indicating that the first operand is greater than the first approximation-number evaluation threshold and the second comparison result indicating that the second operand is not greater than the first approximation-number evaluation threshold, the multiplexer outputs the first operand. In response to the operator corresponding to the multiplication operation and the first comparison result indicating that the first operand is greater than the first approximation-number evaluation threshold and the second comparison result indicating that the second operand is not greater than the first approximation-number evaluation threshold, the multiplexer outputs the second operand. In response to the operator corresponding to the multiplication operation and the first comparison result indicating that the first operand is greater than the first approximation-number evaluation threshold and the second comparison result indicating that the second operand is greater than the first approximation-number evaluation threshold, the arithmetic logic unit performs the multiplication operation on the first operand and the second operand, and the multiplexer outputs the computation result.

In one embodiment, in response to the operator corresponding to a division operation and the first comparison result indicating that the first operand is not greater than the first approximation-number evaluation threshold and the second comparison result indicating that the second operand is greater than the first approximation-number evaluation threshold, the arithmetic logic unit performs the division operation on the first operand and the second operand, and the multiplexer outputs the computation result. In response to the operator corresponding to the division operation and the first comparison result indicating that the first operand is greater than the first approximation-number evaluation threshold and the second comparison result indicating that the second operand is not greater than the first approximation-number evaluation threshold, the multiplexer outputs the first operand. In response to the operator corresponding to the division operation and the first comparison result indicating that the first operand is not greater than the first approximation-number evaluation threshold and the second comparison result indicating that the second operand is not greater than the first approximation-number evaluation threshold, the multiplexer outputs the first operand. In response to the operator corresponding to the division operation and the first comparison result indicating that the first operand is greater than the first approximation-number evaluation threshold and the second comparison result indicating that the second operand is greater than the first approximation-number evaluation threshold, the arithmetic logic unit performs the division operation on the first operand and the second operand, and the multiplexer outputs the computation result.

In one embodiment, the processor further comprises a second register configured to store a second approximation-number evaluation threshold. The processor is further configured to select, according to data types of the first operand and the second operand, the first approximation-number evaluation threshold or the second approximation-number evaluation threshold to be compared with the first operand and the second operand, so as to obtain the first comparison result and the second comparison result.

An embodiment of the present invention provides a computation method. The computation method is executed by a processor. The processor includes a first register, a decoder, and an execution unit. The first register is configured to store a first approximation-number evaluation threshold. The computation method includes using the decoder decode an approximation-number instruction to obtain an operator, a first operand, and a second operand. The computation method further includes using the execution unit to compare the first operand with the first approximation-number evaluation threshold to obtain a first comparison result. The computation method further includes using the execution unit to compare the second operand with the first approximation-number evaluation threshold to obtain a second comparison result. The computation method further includes using the execution unit to selectively output, based on the first comparison result and the second comparison result, the first operand, the second operand, or a computation result. The computation result is obtained by the execution unit performing an operation corresponding to the operator on the first operand and the second operand.

The processor and computation method thereof provided by the present disclosure improve the computation speed of the processor by reducing the number of arithmetic operations (e.g., addition, subtraction, multiplication and division). Furthermore, using the logical evaluation of the comparator to avoid the arithmetic logic unit from performing relatively time-consuming arithmetic operations (e.g., addition, subtraction, multiplication, and division) can reduce the execution time of instructions, thereby improving the instruction execution efficiency of the processor without affecting the accuracy of the calculation results. Therefore, the processor and computation method thereof provided by the present disclosure are quite suitable for AI computation with a large number of matrix operations. In addition, the processor and computation method thereof provided by the present disclosure can be further combined with Single Instruction Multiple Data (SIMD) technology to further improve the execution efficiency of the processor.

### BRIEF DESCRIPTION OF THE DRAWINGS

The present invention can be more fully understood by reading the subsequent detailed description and examples with references made to the accompanying drawings, wherein:

FIG. 1 is a system architecture diagram of a processor according to an embodiment of the present disclosure;

FIG. 2 is a data flow diagram of a computation method according to an embodiment of the present invention;

FIG. 3 is a system architecture diagram of another processor according to an embodiment of the present disclosure; and

FIG. 4 is a data flow diagram of another computation method according to an embodiment of the present invention.

### DETAILED DESCRIPTION OF THE INVENTION

The following description is made for the purpose of illustrating the general principles of the disclosure and should not be taken in a limiting sense. The scope of the disclosure is best determined by reference to the appended claims.

In each of the below embodiments, the same or similar elements or components will be represented by the same reference numerals.

The serial numbers in this description and the scope of the patent application, such as “first”, “second”, etc., are only for convenience of explanation, and there is no sequential relationship between them.

The description of the embodiments of the device or system in this disclosure also applies to the embodiments of the method, and vice versa.

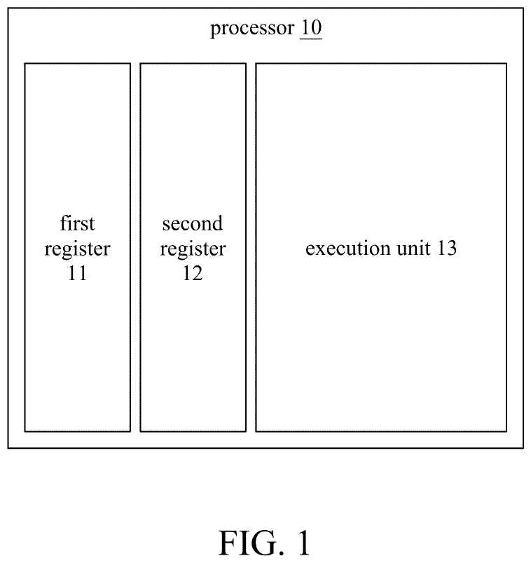

FIG. 1 is a system architecture diagram of a processor 10 according to an embodiment of the present disclosure. As shown in FIG. 1, the processor 10 includes a first register 11, a decoder 12 and an execution unit 13.

The decoder 12 may be a hardware circuit composed of logic gates for decoding instructions. The execution unit 13 may be composed of a plurality of digital circuits (e.g., adders, floating-point multipliers, and shifters, etc.) for performing various computations, such as arithmetic and logic operation.

Although FIG. 1 only shows the first register 11, the decoder 12 and the execution unit 13, people skilled in the art should know that the processor 10 may also include other common basic components, e.g., a control unit (CU), a memory management unit (MMU), a cache or other registers such as general-purpose registers (GPRs), etc., but the present disclosure is not limited thereto.

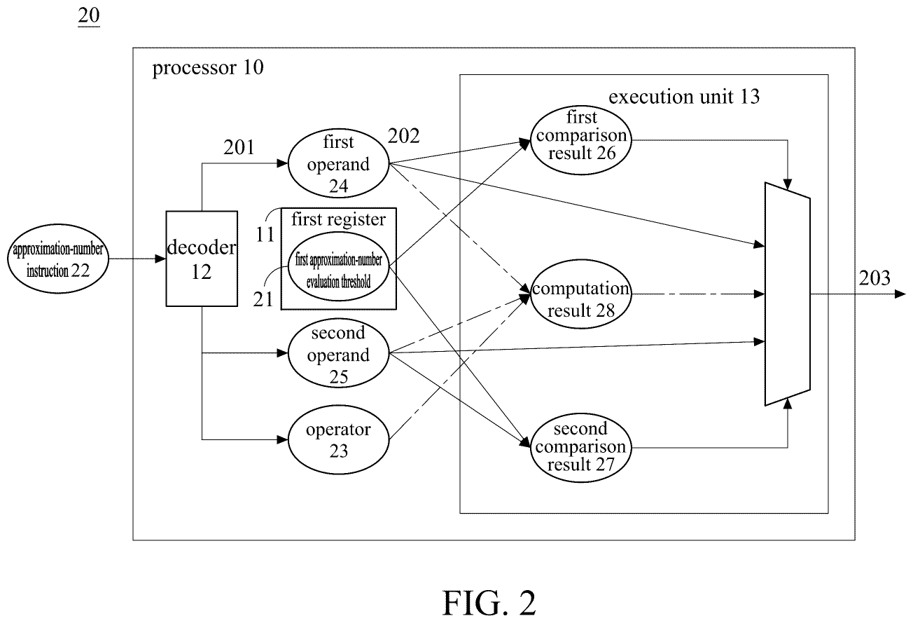

FIG. 2 is a data flow diagram of a computation method 20 according to an embodiment of the present invention. The computation method 20 may be executed by the processor 10 of FIG. 1. As shown in FIG. 2, the first register 11 stores a first approximation-number evaluation threshold 21. The following describes steps 201 to 203 of the computation method 20.

In step 201, the decoders 12 decodes an approximation-number instruction 22 to obtain an operator 23, a first operand 24 and a second operand 25. The approximation-number instruction 22 is fetched from the instruction memory.

Generally, an operator is an abstract symbol for expressing an operation, such as the addition operator ‘+’, the subtraction operator ‘−’, the multiplication operator ‘*’, and the division operator ‘/’ in arithmetic operators. The operator 23 may be implemented by a corresponding operation code (opcode) in the approximation-number instruction 22. Specifically, the operation code in the approximation-number instruction 22 is used for indicating to the execution unit 13 the operation to be executed. For example, an ADD type instruction may correspond to the addition operator ‘+’, so the execution unit 13 is instructed to perform an addition operation.

Generally, an operand is the operation object of the aforementioned operator or operation code. In an instruction, an operand may commonly be, for example, an immediate value (i.e., a constant value given directly in the instruction). Alternatively, the operand may be a value read from a register or memory address. For example, the instruction ‘ADD AX, BX’ instructs the processor to perform an addition operation on the data stored in registers AX and BX. Therefore, specifically, the first operand 24 and the second operand 25 can be immediate values specified in the approximation-number instruction 22, data stored in a specified register, or data stored in a specified memory, but the present disclosure is not limited thereto.

In step 202, the execution unit 13 compares the first operand 24 with the first approximation-number evaluation threshold 21 to obtain a first comparison result 26. Similarly, the execution unit 13 compares the second operand 25 with the first approximation-number evaluation threshold 21 to obtain a second comparison result 27. The first comparison result 26 and the second comparison result 27 may be represented by Boolean values, flags, or bit codes, but the present disclosure is not limited thereto. For example, if the value of the first comparison result 26 is 1, it represents that the first operand 24 is greater than the second operand 25. If the value of the first comparison result 26 is 0, it represents that the first operand 24 is less than or equal to the second operand 25.

In step 203, the execution unit 13 selectively outputs the first operand 24, the second operand 25, or a computation result 28 according to the first comparison result 26 and the second comparison result 27. The computation result 28 is obtained by the execution unit 13 performing the operation corresponding to the operator 23 on the first operand 24 and the second operand 25. The operation corresponding to the operator 23 may be any one of addition, subtraction, multiplication and division.

It should be noted that the embodiments in the present disclosure do not limit the execution unit 13 to execute the operation corresponding to the operator 23. In other words, the execution unit 13 will only execute the operation corresponding to the operator 23 when a specific condition is met. In other cases, the execution unit 13 may ignore the operation.

Notably, in the embodiment of the present disclosure, the first approximation-number evaluation threshold 21 is not specified in the approximation-number instruction 22. Instead, the first approximation-number evaluation threshold 21 is specified in the first register 11. This helps prevent decoding delays in the decoder 12 due to varying instruction lengths caused by specifying the first approximation-number evaluation threshold 21 in approximation-number instruction 22. Thereby, the overall execution efficiency of the processor 10 can be enhanced.

In one embodiment, the processor 10 further includes a second register. The second register stores a second approximation-number evaluation threshold. In step 202 of this embodiment, the processor 10 further selects, according to the data type of the first operand 24 and the second operand 25, either the first approximation-number evaluation threshold 21 or the second approximation-number evaluation threshold to be compared with the first operand 24 and the second operand 25, so as to obtain the first comparison result 26 and the second comparison result.

In one example, the first approximation-number evaluation threshold 21 is a threshold with a single-precision floating-point format, and the second approximation-number evaluation threshold is a threshold with a double-precision floating-point format. In step 202 of this example, the processor 10 first determines the data type of the first operand 24 and the second operand 25. If the data type is ‘float’, the first approximation-number evaluation threshold 21 is used as the comparison object of the first operand 24 and the second operand 25. If the data type is ‘double’, the second approximation-number evaluation threshold is used as the comparison object of the first operand 24 and the second operand 25. In one implementation, the logic for determining the comparison objects of the first operand 24 and the second operand 25 can be implemented in an operating system (OS).

For example, the operating system can set a specific register of the underlying processor according to the data type of the upper application program instruction. The value stored in the specific register can determine which of the first approximation-number evaluation threshold 21 and the second approximation-number evaluation threshold is used by the execution unit 13 as the comparison object of the first operand 24 and the second operand 25.

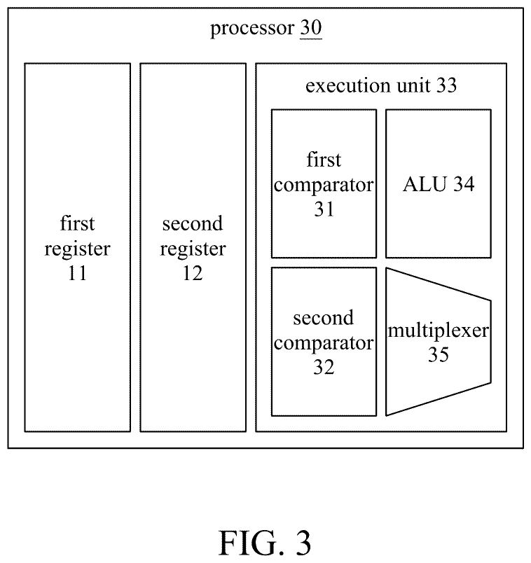

FIG. 3 is a system architecture diagram of a processor 30 according to an embodiment of the present invention. As shown in FIG. 3, compared to the execution unit 13 in FIG. 1, the execution unit 33 includes a first comparator 31, a second comparator 32, an arithmetic logic unit (ALU) 34 and a multiplexer (MUX) 35.

Similar to the processor 10 of FIG. 1, in addition to the above-mentioned components, the processor 30 may also include other common basic components, e.g., a control unit (CU), a memory management unit (MMU), a cache, and other registers such as general-purpose registers (GPRs), etc., but the present disclosure is not limited to this.

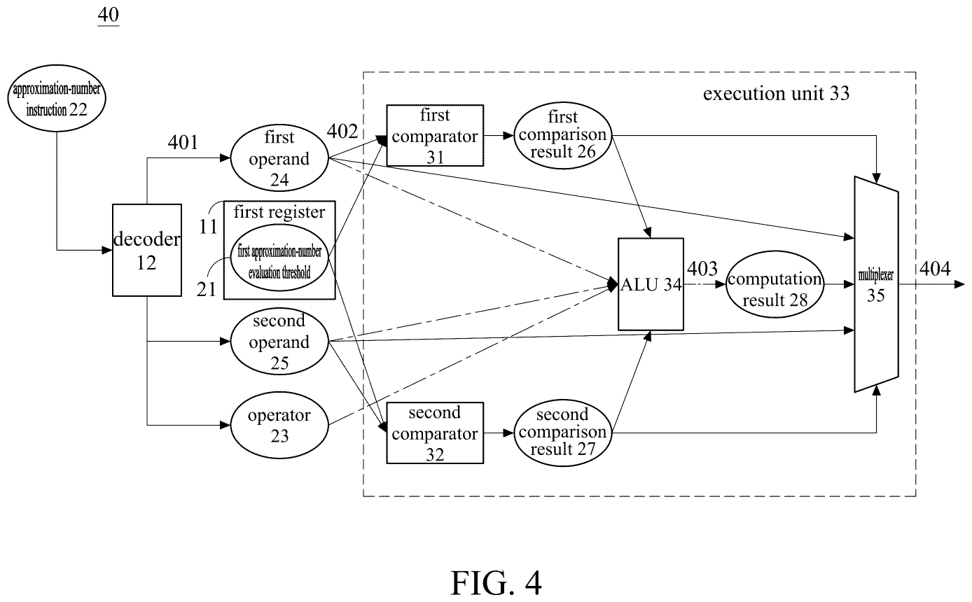

FIG. 4 is a data flow diagram of a computation method 40 according to an embodiment of the present invention. The computation method 40 is implemented in the processor 30 of FIG. 3. As shown in FIG. 4, the computation method 40 includes steps 401 to 403.

In step 401, the decoders 12 decodes an approximation-number instruction 22 to obtain an operator 23, a first operand 24 and a second operand 25.

In step 402, use the first comparator 31 to compare the first operand 24 with the first approximation-number evaluation threshold 21 to obtain a first comparison result 26. Similarly, use the second comparator 32 to compare the second operand 25 with the first approximation-number evaluation threshold 21 to obtain a second comparison result 27.

In step 403, the arithmetic logic unit 34 selectively performs the operation corresponding to the operator 23 on the first operand 24 and the second operand 25 according to the first comparison result 26 and the second comparison result 27.

If the first comparison result 26 and the second comparison result 27 instruct the arithmetic logic unit 34 to perform the operation corresponding to the operator 23 on the first operand 24 and the second operand 25, the arithmetic logic unit 34 outputs the result of performing the operation on the first operand 24 and the second operand 25 as the computation result 28. The operation corresponding to the operator 23 may be any one of addition, subtraction, multiplication and division.

If the first comparison result 26 and the second comparison result 27 do not instruct the arithmetic logic unit 34 to perform the operation corresponding to the operator 23 on the first operand 24 and the second operand 25, the arithmetic logic unit 34 does not perform the operation corresponding to the operator 23 on the first operand 24 and the second operand 25. In one embodiment, the arithmetic logic unit 34 performs no operation and directly outputs a preset value (e.g., 0) as the computation result 28. In one embodiment, the arithmetic logic unit 34 performs no operation and has no output.

Notably, enabling and disabling the arithmetic logic unit 34 according to the first comparison result 26 and the second comparison result 27 helps the arithmetic logic unit 34 reduce the number of operations. This can reduce instruction execution time and even reduce data hazards. Thereby, this improves the overall execution efficiency of the processor 30.

In step 404, the multiplexer 35 selectively outputs the first operand 24, the second operand 25, or the computation result 28 based on the first comparison result 26 and the second comparison result 27.

In a further embodiment, in addition to the first comparison result 26 and the second comparison result 27, the multiplexer 35 further refers to the operator 23, so as to selectively output the first operand 24, the second operand 25, or the computation result 28.

The following describes an embodiment in which the operator 23 corresponds to an addition operation in four cases.

Case 1-1: when the first comparison result 26 indicates that the first operand 24 is not greater than the first approximation-number evaluation threshold 21, and the second comparison result 27 indicates that the second operand 25 is greater than the first approximation-number evaluation threshold, the multiplexer 35 outputs the second operand 25.

Case 1-2: when the first comparison result 26 indicates that the first operand 24 is greater than the first approximation-number evaluation threshold 21, and the second comparison result 27 indicates that the second operand 25 is not greater than the first approximation-number evaluation threshold, the multiplexer 35 outputs the first operand 24.

Case 1-3: when the first comparison result 26 indicates that the first operand 24 is not greater than the first approximation-number evaluation threshold 21, and the second comparison result 27 indicates that the second operand 25 is not greater than the first approximation-number evaluation threshold, the multiplexer 35 outputs the second operand 25.

Case 1-4: when the first comparison result 26 indicates that the first operand 24 is greater than the first approximation-number evaluation threshold 21, and the second comparison result 27 indicates that the second operand 25 is greater than the first approximation-number evaluation threshold, the arithmetic logic unit 34 performs the addition operation on the first operand 24 and the second operand 25, and the multiplexer 35 outputs the computation result 28.

In case 1-1, the approximation-number instruction 22 that adds the first operand 24 and the second operand 25 can obtain the second operand 25. Therefore, it can be regarded as that the execution unit 33 performs a zero-reduction operation on the first operand 24. In other words, the first operand 24 is regarded as zero or reduced to zero.

Similarly, in case 1-2, the approximation-number instruction 22 that adds the first operand 24 and the second operand 25 can obtain the first operand 24. Therefore, it can be regarded as that the execution unit 33 performs a zero-reduction operation on the second operand 25. In other words, the second operand 25 is regarded as zero or reduced to zero.

The following describes an embodiment in which the operator 23 corresponds to a subtraction operation in four cases.

Case 2-1: when the first comparison result 26 indicates that the first operand 24 is not greater than the first approximation-number evaluation threshold 21, and the second comparison result 27 indicates that the second operand 25 is greater than the first approximation-number evaluation threshold, the arithmetic logic unit 34 performs the subtraction operation on the first operand 24 and the second operand 25, and the multiplexer 35 outputs the computation result 28.

Case 2-2: when the first comparison result 26 indicates that the first operand 24 is greater than the first approximation-number evaluation threshold 21, and the second comparison result 27 indicates that the second operand 25 is not greater than the first approximation-number evaluation threshold, the multiplexer 35 outputs the first operand 24.

Case 2-3: when the first comparison result 26 indicates that the first operand 24 is not greater than the first approximation-number evaluation threshold 21, and the second comparison result 27 indicates that the second operand 25 is not greater than the first approximation-number evaluation threshold, the multiplexer 35 outputs the first operand 24.

Case 2-4: when the first comparison result 26 indicates that the first operand 24 is greater than the first approximation-number evaluation threshold 21, and the second comparison result 27 indicates that the second operand 25 is greater than the first approximation-number evaluation threshold, the arithmetic logic unit 34 performs the subtraction operation on the first operand 24 and the second operand 25, and the multiplexer 35 outputs the computation result 28.

In case 2-2 and case 2-3, the approximation-number instruction 22 that subtracts the second operand 25 from the first operand 24 can obtain the first operand 24. Therefore, it can be regarded as that the execution unit 33 performs a zero-reduction operation on the second operand 25. In other words, the second operand 25 is regarded as zero or reduced to zero.

The following describes an embodiment in which the operator 23 corresponds to an multiplication operation in four cases.

Case 3-1: when the first comparison result 26 indicates that the first operand 24 is not greater than the first approximation-number evaluation threshold 21, and the second comparison result 27 indicates that the second operand 25 is greater than the first approximation-number evaluation threshold, the multiplexer 35 outputs the second operand 25.

Case 3-2: when the first comparison result 26 indicates that the first operand 24 is greater than the first approximation-number evaluation threshold 21, and the second comparison result 27 indicates that the second operand 25 is not greater than the first approximation-number evaluation threshold, the multiplexer 35 outputs the first operand 24.

Case 3-3: when the first comparison result 26 indicates that the first operand 24 is not greater than the first approximation-number evaluation threshold 21, and the second comparison result 27 indicates that the second operand 25 is not greater than the first approximation-number evaluation threshold, the multiplexer 35 outputs the second operand 25.

Case 3-4: when the first comparison result 26 indicates that the first operand 24 is greater than the first approximation-number evaluation threshold 21, and the second comparison result 27 indicates that the second operand 25 is greater than the first approximation-number evaluation threshold, the arithmetic logic unit 34 performs the multiplication operation on the first operand 24 and the second operand 25, and the multiplexer 35 outputs the computation result 28.

In case 3-1, the approximation-number instruction 22 that multiplies the first operand 24 and the second operand 25 can obtain the second operand 25. Therefore, it can be regarded as that the execution unit 33 performs an one-reduction operation on the first operand 24. In other words, the first operand 24 is regarded as one or reduced to one. Similarly, in case 3-2, the approximation-number instruction 22 that multiplies the first operand 24 and the second operand 25 can obtain the first operand 24. Therefore, it can be regarded as that the execution unit 33 performs an one-reduction operation on the second operand 25. In other words, the second operand 25 is regarded as one or reduced to one.

The following describes an embodiment in which the operator 23 corresponds to a division operation in four cases.

Case 4-1: when the first comparison result 26 indicates that the first operand 24 is not greater than the first approximation-number evaluation threshold 21, and the second comparison result 27 indicates that the second operand 25 is greater than the first approximation-number evaluation threshold, the arithmetic logic unit 34 performs the division operation on the first operand 24 and the second operand 25, and the multiplexer 35 outputs the computation result 28.

Case 4-2: when the first comparison result 26 indicates that the first operand 24 is greater than the first approximation-number evaluation threshold 21, and the second comparison result 27 indicates that the second operand 25 is not greater than the first approximation-number evaluation threshold, the multiplexer 35 outputs the first operand 24.

Case 4-3: when the first comparison result 26 indicates that the first operand 24 is not greater than the first approximation-number evaluation threshold 21, and the second comparison result 27 indicates that the second operand 25 is not greater than the first approximation-number evaluation threshold, the multiplexer 35 outputs the first operand 24.

Case 4-4: when the first comparison result 26 indicates that the first operand 24 is greater than the first approximation-number evaluation threshold 21, and the second comparison result 27 indicates that the second operand 25 is greater than the first approximation-number evaluation threshold, the arithmetic logic unit 34 performs the division operation on the first operand 24 and the second operand 25, and the multiplexer 35 outputs the computation result 28.

In case 4-2 and case 4-3, the approximation-number instruction 22 that divides the first operand 24 by the second operand 25 can obtain the first operand 24. Therefore, it can be regarded as that the execution unit 33 performs an one-reduction operation on the second operand 25. In other words, the second operand 25 is regarded as one or reduced to one.

In one embodiment, the first comparator 31 and the second comparator 32 both perform a ‘greater than’ comparison logic. In other words, the first comparator 31 determines whether the first operand 24 is greater than the first approximation-number evaluation threshold 21. If the first operand 24 is greater, then the first comparator 31 outputs True. Otherwise, the first comparator 31 outputs False. Similarly, the second comparator 32 determines whether the second operand 25 is greater than the first approximation-number evaluation threshold 21. If the second operand 25 is greater, the second comparator 32 outputs True. Otherwise, the second comparator 32 outputs False.

In one example, the evaluation logic of the multiplexer 35 is as shown in the <Table 1>.

TABLE 1

| | first operand 24 > | second operand 25 > | |
|---|---|---|---|
| | first approximation- | first approximation- | |
| | number evaluation | number evaluation | |
| operator 23 | threshold 21 | threshold 21 | output of multiplexer 35 |
| + | F | T | second operand 25 |
| | T | F | first operand 24 |
| | F | F | second operand 25 |
| | T | T | computation result 28 |
| − | F | T | computation result 28 |
| | T | F | first operand 24 |
| | F | F | first operand 24 |
| | T | T | computation result 28 |
| * | F | T | second operand 25 |
| | T | F | first operand 24 |
| | F | F | second operand 25 |
| | T | T | computation result 28 |
| / | F | T | computation result 28 |
| | T | F | first operand 24 |
| | F | F | first operand 24 |
| | T | T | computation result 28 |

In one embodiment, the processor 10 and the processor 30 may be further expanded to support Single Instruction Multiple Data (SIMD) technology. Traditional single instruction single data (SISD) technology may only perform operations on one piece of data at a time. In contrast, SIMD technology can speed up calculations by performing the same operation on multiple data at the same time.

SIMD technology usually uses vector registers to store data. Compared to general-purpose registers, vector registers can store more data. For example, a 256-bit vector register can store eight 32-bit integers or four 64-bit floating-point numbers. In addition, SIMD technology also uses multiple execution units to perform the same operation on multiple data in the vector register in parallel at the same time.

Therefore, the processor of the present disclosure may include a plurality of execution units and a plurality of vector registers, and further extend the computation methods 20 and 40 of the present disclosure to each execution unit in the processor. In this way, each execution unit will correspond to one piece of data in a certain vector register as its first operand, and correspond to one piece of data in another vector register as its second operand. In other words, for each operand, its first operand may be one of the data in a certain vector register, and its second operand may be one of the data in another vector register. Then, each execution unit performs comparison and selective output as in methods 20 and 40.

For example, the processor of the present disclosure may include a first execution unit, a second execution unit, a first register, and a second register. The first execution unit is responsible for performing operations on the first data in the first vector register (its first operand) and the first data in the second vector register (its second operand). The second execution unit is responsible for performing operations on the second data of the first vector register (its first operand) and the second data of the second vector register (its second operand). The computation speed can be further improved through parallel computing.

The processor and computation method thereof provided by the present disclosure improve the computation speed of the processor by reducing the number of arithmetic operations (e.g., addition, subtraction, multiplication and division). Furthermore, using the logical evaluation of the comparator to avoid the arithmetic logic unit from performing relatively time-consuming arithmetic operations (e.g., addition, subtraction, multiplication, and division) can reduce the execution time of instructions, thereby improving the instruction execution efficiency of the processor without affecting the accuracy of the calculation results. Therefore, the processor and computation method thereof provided by the present disclosure are quite suitable for AI computation with a large number of matrix operations. In addition, the processor and computation method thereof provided by the present disclosure can be further combined with Single Instruction Multiple Data (SIMD) technology to further improve the execution efficiency of the processor.

The above paragraphs are described in various ways. Obviously, the teachings of this article can be implemented in a variety of ways, and any specific architecture or functionality disclosed in the examples is only a representative situation. Based on the teachings of this article, it should be understood in the art that each aspect disclosed in this article can be implemented independently, or two or more aspects can be combined and implemented.

Although the present disclosure has been described using embodiments as above, they are not intended to limit the present disclosure. A person skilled in the art may make some modifications without departing from the spirit and scope of the present disclosure. Therefore, the protection scope of the disclosure shall be determined by the appended patent application scope.

What is claimed is:

1. A processor, comprising:
a first register, configured to store a first approximation-number evaluation threshold;
a decoder, configured to decode an approximation-number instruction to obtain an operator, a first operand and a second operand; and
an execution unit, configured to:
compare the first operand with the first approximation-number evaluation threshold to obtain a first comparison result;
compare the second operand with the first approximation-number evaluation threshold to obtain a second comparison result; and
selectively output, based on the first comparison result and the second comparison result, the first operand, the second operand or a computation result;
wherein the computation result is obtained by the execution unit performing an operation corresponding to the operator on the first operand and the second operand.

2. The processor as claimed in claim 1, wherein the execution unit comprises:
a first comparator, configured to compare the first operand with the first approximation-number evaluation threshold to obtain the first comparison result;
a second comparator, configured to compare the second operand with the first approximation-number evaluation threshold to obtain the second comparison result;
an arithmetic logic unit, configured to selectively perform, based on the first comparison result and the second comparison result, the operation corresponding to the operator on the first operand and the second operand; and
a multiplexer, configured to selectively output, based on the first comparison result and the second comparison result, the first operand, the second operand or the computation result.

3. The processor as claimed in claim 2, wherein:
in response to the operator corresponding to an addition operation and the first comparison result indicating that the first operand is not greater than the first approximation-number evaluation threshold and the second comparison result indicating that the second operand is greater than the first approximation-number evaluation threshold, the multiplexer outputs the second operand;
in response to the operator corresponding to the addition operation and the first comparison result indicating that the first operand is greater than the first approximation-number evaluation threshold and the second comparison result indicating that the second operand is not greater than the first approximation-number evaluation threshold, the multiplexer outputs the first operand;
in response to the operator corresponding to the addition operation and the first comparison result indicating that the first operand is not greater than the first approximation-number evaluation threshold and the second comparison result indicating that the second operand is not greater than the first approximation-number evaluation threshold, the multiplexer outputs the second operand; and
in response to the operator corresponding to the addition operation and the first comparison result indicating that the first operand is greater than the first approximation-number evaluation threshold and the second comparison result indicating that the second operand is greater than the first approximation-number evaluation threshold, the arithmetic logic unit performs the addition operation on the first operand and the second operand, and the multiplexer outputs the computation result.

4. The processor as claimed in claim 2, wherein:
in response to the operator corresponding to a subtraction operation and the first comparison result indicating that the first operand is not greater than the first approximation-number evaluation threshold and the second comparison result indicating that the second operand is greater than the first approximation-number evaluation threshold, the arithmetic logic unit performs the subtraction operation on the first operand and the second operand, and the multiplexer outputs the computation result;
in response to the operator corresponding to the subtraction operation and the first comparison result indicating that the first operand is greater than the first approximation-number evaluation threshold and the second comparison result indicating that the second operand is not greater than the first approximation-number evaluation threshold, the multiplexer outputs the first operand;
in response to the operator corresponding to the subtraction operation and the first comparison result indicating that the first operand is not greater than the first approximation-number evaluation threshold and the second comparison result indicating that the second operand is not greater than the first approximation-number evaluation threshold, the multiplexer outputs the first operand; and
in response to the operator corresponding to the subtraction operation and the first comparison result indicating that the first operand is greater than the first approximation-number evaluation threshold and the second comparison result indicating that the second operand is greater than the first approximation-number evaluation threshold, the arithmetic logic unit performs the subtraction operation on the first operand and the second operand, and the multiplexer outputs the computation result.

5. The processor as claimed in claim 2, wherein:
in response to the operator corresponding to a multiplication operation and the first comparison result indicating that the first operand is not greater than the first approximation-number evaluation threshold and the second comparison result indicating that the second operand is greater than the first approximation-number evaluation threshold, the multiplexer outputs the second operand;
in response to the operator corresponding to the multiplication operation and the first comparison result indicating that the first operand is greater than the first approximation-number evaluation threshold and the second comparison result indicating that the second operand is not greater than the first approximation-number evaluation threshold, the multiplexer outputs the first operand;
in response to the operator corresponding to the multiplication operation and the first comparison result indicating that the first operand is not greater than the first approximation-number evaluation threshold and the second comparison result indicating that the second operand is not greater than the first approximation-number evaluation threshold, the multiplexer outputs the second operand; and
in response to the operator corresponding to the multiplication operation and the first comparison result indicating that the first operand is greater than the first approximation-number evaluation threshold and the second comparison result indicating that the second operand is greater than the first approximation-number evaluation threshold, the arithmetic logic unit performs the multiplication operation on the first operand and the second operand, and the multiplexer outputs the computation result.

6. The processor as claimed in claim 2, wherein:
in response to the operator corresponding to a division operation and the first comparison result indicating that the first operand is not greater than the first approximation-number evaluation threshold and the second comparison result indicating that the second operand is greater than the first approximation-number evaluation threshold, the arithmetic logic unit performs the division operation on the first operand and the second operand, and the multiplexer outputs the computation result;
in response to the operator corresponding to the division operation and the first comparison result indicating that the first operand is greater than the first approximation-number evaluation threshold and the second comparison result indicating that the second operand is not greater than the first approximation-number evaluation threshold, the multiplexer outputs the first operand;
in response to the operator corresponding to the division operation and the first comparison result indicating that the first operand is not greater than the first approximation-number evaluation threshold and the second comparison result indicating that the second operand is not greater than the first approximation-number evaluation threshold, the multiplexer outputs the first operand; and
in response to the operator corresponding to the division operation and the first comparison result indicating that the first operand is greater than the first approximation-number evaluation threshold and the second comparison result indicating that the second operand is greater than the first approximation-number evaluation threshold, the arithmetic logic unit performs the division operation on the first operand and the second operand, and the multiplexer outputs the computation result.

7. The processor as claimed in claim 1, further comprising:
a second register, configured to store a second approximation-number evaluation threshold;
wherein the processor is further configured to:
select, according to data types of the first operand and the second operand, the first approximation-number evaluation threshold or the second approximation-number evaluation threshold to be compared with the first operand and the second operand, so as to obtain the first comparison result and the second comparison result.

8. A computation method, executed by a processor, wherein the processor comprises a first register, a decoder, and an execution unit, wherein the first register is configured to store a first approximation-number evaluation threshold, and the computation method comprises:
using the decoder to decode an approximation-number instruction, so as to obtain an operator, a first operand, and a second operand; and
using the execution unit to perform following operations:
comparing the first operand with the first approximation-number evaluation threshold to obtain a first comparison result;
comparing the second operand with the first approximation-number evaluation threshold to obtain a second comparison result; and
selectively outputting, based on the first comparison result and the second comparison result, the first operand, the second operand or a computation result;
wherein the computation result is obtained by the execution unit performing an operation corresponding to the operator on the first operand and the second operand.

9. The computation method as claimed in claim 8, wherein the execution unit comprises a first comparator, a second comparator, an arithmetic logic unit, and a multiplexer, wherein the computation method further comprises:
using the first comparator to compare the first operand with the first approximation-number evaluation threshold, so as to obtain the first comparison result;
using the second comparator to compare the second operand with the first approximation-number evaluation threshold, so as to obtain the second comparison result;
using the arithmetic logic unit to selectively perform, based on the first comparison result and the second comparison result, the operation corresponding to the operator on the first operand and the second operand; and
using the multiplexer to selectively output, based on the first comparison result and the second comparison result, the first operand, the second operand or the computation result.

10. The computation method as claimed in claim 9, further comprising:
in response to the operator corresponding to an addition operation and the first comparison result indicating that the first operand is not greater than the first approximation-number evaluation threshold and the second comparison result indicating that the second operand is greater than the first approximation-number evaluation threshold, using the multiplexer to output the second operand;
in response to the operator corresponding to the addition operation and the first comparison result indicating that the first operand is greater than the first approximation-number evaluation threshold and the second comparison result indicating that the second operand is not greater than the first approximation-number evaluation threshold, using the multiplexer to output the first operand;
in response to the operator corresponding to the addition operation and the first comparison result indicating that the first operand is not greater than the first approximation-number evaluation threshold and the second comparison result indicating that the second operand is not greater than the first approximation-number evaluation threshold, using the multiplexer to output the second operand; and
in response to the operator corresponding to the addition operation and the first comparison result indicating that the first operand is greater than the first approximation-number evaluation threshold and the second comparison result indicating that the second operand is greater than the first approximation-number evaluation threshold, using the arithmetic logic unit to perform the addition operation on the first operand and the second operand, and using the multiplexer to output the computation result.

11. The computation method as claimed in claim 9, wherein:
in response to the operator corresponding to a subtraction operation and the first comparison result indicating that the first operand is not greater than the first approximation-number evaluation threshold and the second comparison result indicating that the second operand is greater than the first approximation-number evaluation threshold, using the arithmetic logic unit to perform the subtraction operation on the first operand and the second operand, and using the multiplexer to output the computation result;
in response to the operator corresponding to the subtraction operation and the first comparison result indicating that the first operand is greater than the first approximation-number evaluation threshold and the second comparison result indicating that the second operand is not greater than the first approximation-number evaluation threshold, using the multiplexer to output the first operand;
in response to the operator corresponding to the subtraction operation and the first comparison result indicating that the first operand is not greater than the first approximation-number evaluation threshold and the second comparison result indicating that the second operand is not greater than the first approximation-number evaluation threshold, using the multiplexer to output the first operand; and
in response to the operator corresponding to the subtraction operation and the first comparison result indicating that the first operand is greater than the first approximation-number evaluation threshold and the second comparison result indicating that the second operand is greater than the first approximation-number evaluation threshold, using the arithmetic logic unit to perform the subtraction operation on the first operand and the second operand, and using the multiplexer to output the computation result.

12. The computation method as claimed in claim 9, further comprising:
in response to the operator corresponding to a multiplication operation and the first comparison result indicating that the first operand is not greater than the first approximation-number evaluation threshold and the second comparison result indicating that the second operand is greater than the first approximation-number evaluation threshold, using the multiplexer to output the second operand;
in response to the operator corresponding to the multiplication operation and the first comparison result indicating that the first operand is greater than the first approximation-number evaluation threshold and the second comparison result indicating that the second operand is not greater than the first approximation-number evaluation threshold, using the multiplexer to output the first operand;
in response to the operator corresponding to the multiplication operation and the first comparison result indicating that the first operand is not greater than the first approximation-number evaluation threshold and the second comparison result indicating that the second operand is not greater than the first approximation-number evaluation threshold, using the multiplexer to output the second operand; and
in response to the operator corresponding to the multiplication operation and the first comparison result indicating that the first operand is greater than the first approximation-number evaluation threshold and the second comparison result indicating that the second operand is greater than the first approximation-number evaluation threshold, using the arithmetic logic unit to perform the multiplication operation on the first operand and the second operand, and using the multiplexer to output the computation result.

13. The computation method as claimed in claim 9, further comprising:
in response to the operator corresponding to a division operation and the first comparison result indicating that the first operand is not greater than the first approximation-number evaluation threshold and the second comparison result indicating that the second operand is greater than the first approximation-number evaluation threshold, using the arithmetic logic unit to perform the division operation on the first operand and the second operand, and using the multiplexer to output the computation result;
in response to the operator corresponding to the division operation and the first comparison result indicating that the first operand is greater than the first approximation-number evaluation threshold and the second comparison result indicating that the second operand is not greater than the first approximation-number evaluation threshold, using the multiplexer to output the first operand;
in response to the operator corresponding to the division operation and the first comparison result indicating that the first operand is not greater than the first approximation-number evaluation threshold and the second comparison result indicating that the second operand is not greater than the first approximation-number evaluation threshold, using the multiplexer to output the first operand; and
in response to the operator corresponding to the division operation and the first comparison result indicating that the first operand is greater than the first approximation-number evaluation threshold and the second comparison result indicating that the second operand is greater than the first approximation-number evaluation threshold, using the arithmetic logic unit to perform the division operation on the first operand and the second operand, and using the multiplexer to output the computation result.

14. The computation method as claimed in claim 8, wherein the processor further comprises a second register configured to store a second approximation-number evaluation threshold, wherein the computation method further comprises:
selecting, according to data types of the first operand and the second operand, the first approximation-number evaluation threshold or the second approximation-number evaluation threshold to be compared with the first operand and the second operand, so as to obtain the first comparison result and the second comparison result.
